(19) United States
(12) Patent Application Publication
(10) Pub. No.: US 2004/0066276 A1
(43) Pub. Date: Apr. 8, 2004

(54) Biometric identification and reporting system

(76) Inventors: Jeffrey R. Gile, Alameda, CA (US); S. Ragubathi R. Subramaniam, Ipoh (MY)

Correspondence Address: Donald W. Meeker, 924 East Ocean Front, # E, Newport Beach, CA, 92661, US

(21) Appl. No.: 10/263,784

(22) Filed: Oct. 2, 2002

(51) Int. Cl. H04Q 1/00

(52) U.S. Cl. 340/5.53

(57) ABSTRACT

A series of biometric information input devices, such as a fingerprint scanners are connected with onsite computers to monitor attendance at desired locations. The computers compare attendee biometric data with stored data for matches. Absences are automatically sent to a central computer after a brief time interval allowing corrections by an authorized computer operator. The central computer compares the absences with programmed excused absences and automatically reports absences to persons responsible for the absentees via phone, FAX, pager, E-mail, or other instant communication vehicles after a brief time interval allowing for human corrections. Portable fingerprint scanners and handheld computers may be used at any location.

### BACKGROUND OF THE INVENTION

1. Field of the Invention

This invention relates to a biometric identification system, and in particular to a biometric identification system and computerized automated matching system, and automated reporting system used, among other applications, for attendance at schools and reporting absences to parents instantaneously.

2. Description of the Prior Art

Despite tremendous technological progress that has taken place in the western world over the last two decades, various social and economic changes over the same period have produced certain negative impacts on the structure and function of educational systems, most notably in the United States. With unanimous agreement educators now acknowledge that one of the most fundamental problems resides in the fact that the level of communication and interaction that once existed between teacher and parent and school and parent has dropped to an unprecedented low.

The parents of school children are in a difficult situation. The first sign of a child's bad behavior is missing classes, but parents can't easily monitor student attendance.

Various attempts have been made at monitoring attendance, but they lack an integrated system which instantly notifies parents of the situation.

U.S. Pat. No. 6,272,562, issued Aug. 7, 2001 to Scott, et al., claims an access control unit interface between a fingerprint scanner and a host processor. A daughter card is coupled between the fingerprint scanner, various access control peripherals, and the host processor. The host processor can be any commercially available processor. The daughter card handles real-time and interactive access control events. The daughter card may include an access control interface processor. The access control interface processor may include a display interface module, a keyboard module, a Wiegand interface module, a finger detect interface module, a LED interface module, and a serial communication module.

U.S. Pat. No. 6,111,977, issued Aug. 29, 2000 to Scott, et al., describes a portable fingerprint recognition transmitter that is compact, being less than the size of a cigarette pack, allowing the fingerprint recognition transmitter to be carried by an individual in a pocket or purse. The fingerprint recognition transmitter operates to take the image of the fingerprint and formulates a fingerprint image capable of transmitting through infrared or radio frequency to a receiver having previously stored fingerprint images so as to cause a comparison between the image taken and the image stored for purposes of unlocking a security area.

U.S. Pat. No. 6,075,455, issued Jun. 13, 2000 to DiMaria, et al., discloses a biometric time and attendance device for scanning an epidermal portion of a human body, generating an epidermal topographical pattern and transmitting the epidermal topographical pattern to a host computer for determining access privileges and for updating epidermal topographical database.

U.S. Pat. No. 6,173,153, issued Jan. 9, 2001 to Dean Bittman, indicates an apparatus for taking school attendance including a central office computer 101 interfaced with a plurality of attendance telephones 102. Typically, the interface is based on telephone lines or similar hard-wired network. Each AT device may therefore communicate with the central office computer or another AT device by data transmitted through the central office computer. A telephone interface 104 allows the central office computer to outside computers 105, including particularly the school district's central computer and database. The structure and organization of the software associated with the apparatus includes functionality related to the taking, recording and transmitting of school attendance and other purposes.

U.S. Pat. No. 5,294,229, issued Mar. 15, 1994 to Hartzell, et al., puts forth an electronic communication system and method of utilizing same for telephonically exchanging between teacher and parent information regarding student homework assignments, attendance, classroom behavior, and academic performance. During the school day each teacher carries a small, portable terminal (1) which not only accepts manually entered numeric data, but also produces digital audio recordings of voiced homework assignments, announcements, and comments made by the teacher. Upon leaving at the end of the day, the teacher returns the remote terminal to a centrally located storage rack (2). The system's central computer (3), electronically connected to the rack, then extracts data from the newly inserted terminal. The numeric and audio information thus gathered from a multiplicity of such terminals is organized by the computer and made telephonically available to participating parents.

U.S. Pat. No. 6,073,841, issued Jun. 13, 2000 to Walton, provides a system for tracking continuing education including a secure stored data device, such as a smart card, storing practitioner-specific data, and a read/write device for communicating with the secure stored data device and for writing course attendance information for the practitioner to the secure stored data device. A professional education server initiates the secure stored data device and the read/write device, accepts data from the secure stored data device and the read/write device, verifies compliance with education requirements and verifies consistency in the data sets.

U.S. Pat. No. 6,394,356, issued May 28, 2002 to Anthony Zagami, shows an access control system for monitoring human ingress and egress comprised of an input means for creating a unique identifier to be stored in a database. The unique identifier includes a digital image of the person, a digital image of the unique identifier, and alphanumeric identification data. A processing means coupled to said input means is operable to perform the steps of storing the unique identifier as a computer-readable file in the database, recording the arrival date and time of a person; creating a tracking record associated with the unique identifier. The unique identifier can be displayed on a monitor coupled to the processing means. A printer coupled to the processing means generates an access pass on portable media which includes a viewable image of the person and the identification document, and alphanumeric identification data for the person. The access pass can also include machine readable media which comprises a coded representation of the unique identifier. The system of the invention can include a sensing mechanism operable to interpret the machine-readable media. Access permission designators can be associated with the unique identifier in the database to approve or deny access, or to grant selective access.

U.S. Pat. No. 4,731,525, issued Mar. 15, 1988 to John R. Hice, concerns a modular microprocessor-based code printing and reading system, adapted to print a personal coded identifier and other codes relating to categories of school-attendance record keeping on a form, and to read the codes from the form to generate data for processing thereof. The system is particularly adapted for use in the school-attendance record keeping process, with the codes including a bar code, representing an identifier assigned to the person so identified. The system includes a laser printer, microprocessor-based, operable in response to a laser control program, for printing the codes associated with the particular person at the appropriate location on the form. The system further includes a portable compact reader, microprocessor-based, which includes a wand adapted to sense the bar code on the form. The reader is operable in response to control by the operator, and to a reader control program, for reading the bar code, to generate data relating to the person identified thereby for processing thereof.

What is needed is a system that will inform the parents immediately if a student is absent automatically, with no actions needed by the teacher or parent.

### SUMMARY OF THE INVENTION

An object of the present invention is to provide a system that will inform the parents immediately if a student is absent automatically, with no actions needed by the teacher or parent using a computerized system programmed to pick up information from a biometric scanner and, after a time delay to enable teachers to verify any excused absences, notify parents by any of various means that the student is absent.

Another object of the present invention is to provide a positive biometric characteristic identification instantly to establish an accurate record of attendance which is instantly available in real time.

One more object of the present invention is to provide an instant communication means between a school administration, teachers, and parents so that students are safer and parents have greater peace of mind in sending children off to school. If something has happened to a student on the way to school parents will know right away and can immediately initiate action to determine what happened to the child and thereby have a much greater chance in rescuing a child in a healthy condition from dangerous situations where time increases the likelihood of serious danger for the child.

An additional object of the present invention is to provide a positive biometric identification and automated notification system which may be used in a variety of settings including school, work, or anywhere rapid identification and notification of attendance is desired or required.

A further object of the present invention is to provide an automated biometric identification and reporting system which can be used to identify and authenticate individuals authorized to pick up young children after school and have the same instant reporting function.

In brief, a student is positively identified electronically as he or she enters the classroom, then attendance is taken by a classroom computer and the computer notifies the parents by telephone, fax, pager, or e-mail message if the student is missing and does this within a few minutes of the absence.

The electronic identification could be by a card with a magnetic stripe, bar code, or RF (radio frequency) card or key fob, although a better system would use fingerprint identification. Face recognition or pupil recognition would be excellent techniques also, but would have a far greater cost. A biometric measuring technique like fingerprint recognition is better than a card because it can't easily be cheated.

Another RF transponder location other than a card or key fob would be to place the RF device in a shoe. The mating antenna could be in a floor mat. This could be placed in many places in a school to determine the location of each student.

An additional kind of identification card that could be used with this system is a plastic card with an embedded integrated circuit known commercially by some credit card companies as a “Smart Card.” The card is inserted in a reader that makes metallic contact with connection pads on the card.

Another benefit from taking attendance electronically is that it takes less time for the teacher compared with traditional techniques. At the start of class, the teacher can look at a monitor and see the list of who is absent. If the teacher sees an error such as an excused absence due to a class assignment, the teacher can correct the error before the parent is notified.

In the event that a school doesn't want to use the electronic student identification technique, yet still wants to use the parent notification feature, the classroom computer could be used to manually take roll. The list of absent students would then be sent to the office computer over the network. The office computer could then notify parents in the same way as the full system.

Another use of the notification system would be to send other types of information to the parents. For example, grades, homework assignments, requests for meetings, or school events could be broadcast from the system, providing better communications between the school and parents and between teachers and parents.

In the event of a school closure due to a natural or man-caused disaster during the day (e.g. earthquake, fire, flood, chemical release, etc.) all parents could be notified immediately so that they can arrange to pick up their children or to expect them at home. The system also could be used to notify parents of a weather related closure (e.g. snow) before the start of the school day.

The system could have a computer in the main office that could be used to log excused absences and change parental contact preferences. The office computer could also be used to add new students to the database. School wide schedule changes and holidays would be entered on the master schedule in the office computer.

An additional feature could be to have the database available for a hand held computer (PDA), either stored in memory or real time, wirelessly. This could be used by an administrator or teacher or hall monitor who wants to verify where a wandering student should be. It could also be used to reference the database for parent contact information in case of medical emergency or other situation. The database could also contain information on chronic medical problems (e.g. Diabetes, Epilepsy). Alternatively, the student database could note that medical information is available on another device on the child such as in a “Medic Alert Bracelet”, a “Microfiche” card in the wallet, or other.

In a pre-school environment (very young children), there is a concern about which picks put the child at the end of the day. Using this positive identification technique, especially biometric measurement, the parent (or other) who is picking up the child would be verified and logged. This information would then be immediately transmitted to the parent by their pre-set technique (fax, e-mail, phone, pager, etc.).

Another use for a system of this type would be to keep track of employees in several kinds of businesses. It could replace the usual time clock or time card. As employees enter or leave a facility, they can be logged in or out. A benefit of this kind of system over a normal time clock is that it could notify a supervisor in the event that an employee is missing from his normal location. More importantly, it could notify a supervisor if an employee is in a location where he shouldn't be. An employee in a location where he doesn't belong can indicate a potential risk for reasons of safety or potential loss.

An advantage of the present invention is to provide a means for instantly identifying and reporting an absence of an individual, such as a student, from a normally attended activity, such as school and classroom attendance.

Another advantage of the present invention is to provide a positive identification system using unique biometric information, such as fingerprints, to record attendance.

An additional advantage of the present invention is to provide peace of mind for parents and safety for children in accurately monitoring and reporting attendance.

One more advantage of the present invention is to provide a means for accurately identifying who is picking up young children from school and report that results instantly to prevent putting young children in danger.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a diagrammatic view of a computerized instantaneous biometric identification system in a school setting with fingerprint scanners in classrooms and a central school computer for evaluating attendance information and automatically reporting absences immediately to parents;

FIG. 2 is an enlarged view of one of the classrooms of FIG. 1 showing the classroom components of the identification system;

FIG. 3 is an enlarged view of one of the central school computer in the office of FIG. 1 showing the school office computer for evaluating and reporting absences based on the biometric in formation gathered from students;

FIG. 4 is a flow diagram showing the process involved in identifying students by fingerprints, comparing the fingerprints with enrollment records, checking for corrections, such as excused absences, and reporting absences to the school office computer;

FIG. 5 is a flow diagram showing the process of reviewing the absentee information and activating the reporting of the absentees to the parents or other guardians;

FIG. 6 is a flow diagram showing the process for entering data into the computer system to be used with the biometric identification and reporting system;

FIG. 7 is an elevational view of information visible on the computer monitor of the classroom computer during the fingerprint identification check for absences;

FIG. 8 is an elevational view of information visible on the computer monitor of the classroom computer at the end of the fingerprint identification check for absences when the computer is about to automatically transmit the information to the school office computer;

FIG. 9 is an elevational view of information visible on the computer monitor of the office computer after the fingerprint identification check for absences when the computer is about to send the information to report the absence;

FIG. 10 is an elevational view of information visible on the computer monitor of the office computer showing the message sent to a parent to report the absence;

FIG. 11 is an elevational view of information visible on the computer monitor of the office computer during the operation of adding new student biometric and statistical information into the system;

FIG. 12 is an elevational view of information visible on the computer monitor of the office computer showing the excused absences of a student from particular classes.

### BEST MODE FOR CARRYING OUT THE INVENTION

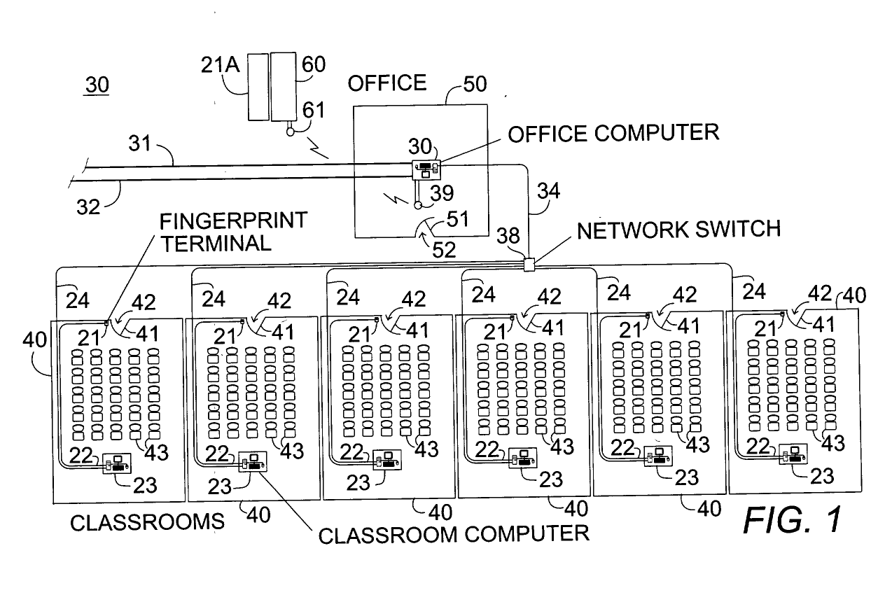

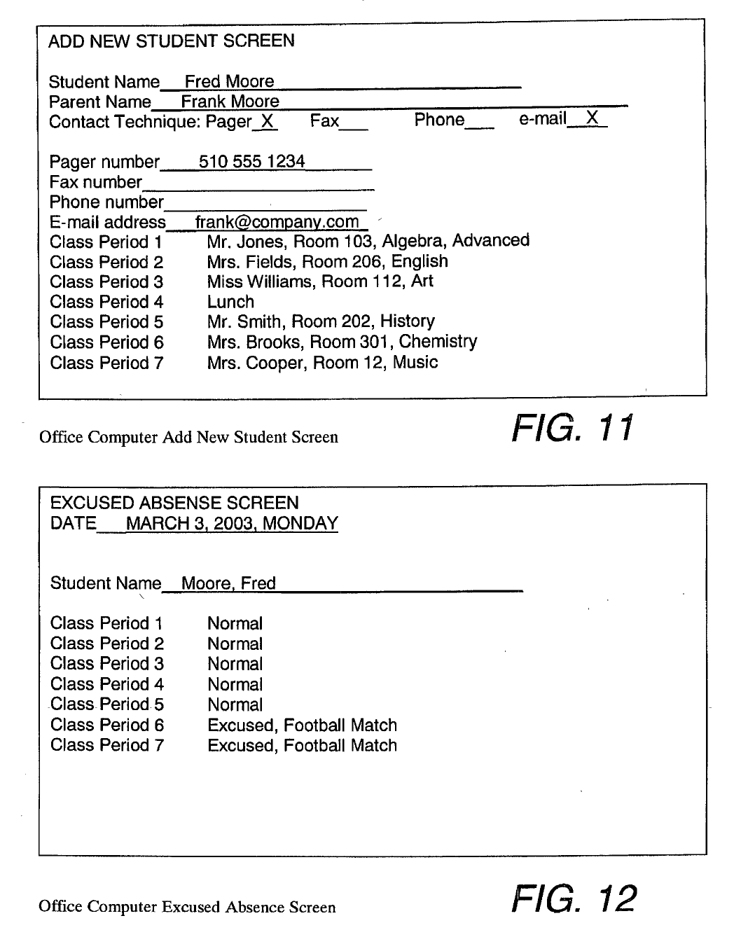

In FIGS. 1-12, an automated identification and reporting system 20 for inputting and analyzing biometric information to detect and report absences automatically and instantaneously comprises one or more biometric information inputting means ,such as a fingerprint scanner 21, one or more onsite computer means, such as personal computers 23, communicating with the biometric information inputting means, and a central computer means, such as a personal computer 30, communicating with the one or more onsite computer means.

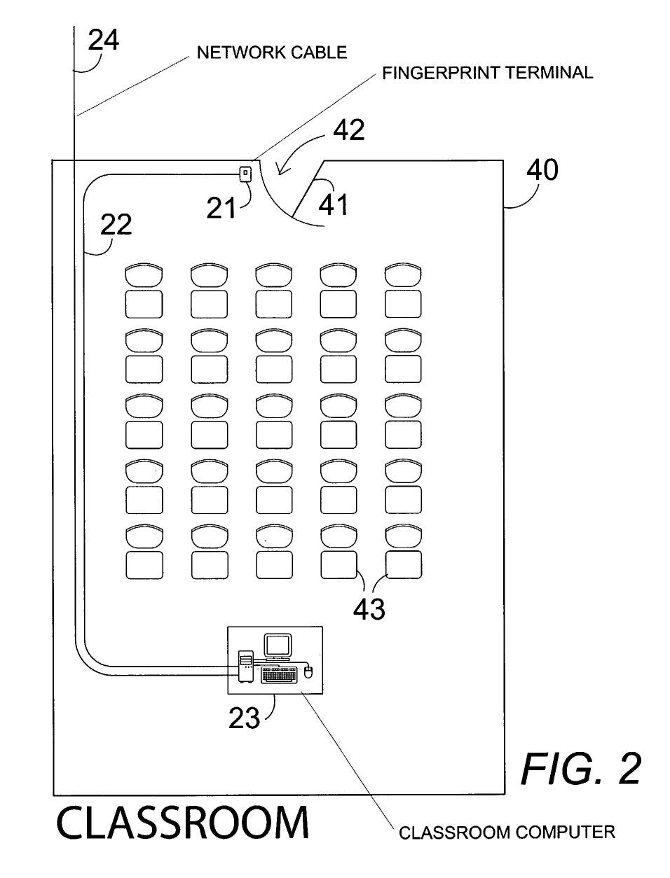

In FIGS. 1 and 2, a fingerprint scanner 21 is used as an automated biometric information inputting means for receiving biometric information, in this case fingerprints, from individuals at a location where the individuals are scheduled for attendance, such as at the entrance 42 to a classroom 40 through the door 41 portal.

A programmed onsite computer means, such as an onsite personal computer 23, is positioned at the location, in this case the classroom 40, with each onsite personal computer 23 in each classroom communicating via a cable 22 with the fingerprint scanner 21 biometric information inputting means. Each computer means, the personal computer 23, is programmed with a timed sequence of recording the information from the fingerprint scanner 21 and comparing the stored biometric information of the individuals who are scheduled for attendance with the biometric information input by the individuals actually in attendance to detect absences and allow a set indicated period of time for human input to make corrections, in this case possibly concerning excused absences from the class known by the teacher or actual visual awareness of students in their seats 43 who haven't checked in using the fingerprint scanner 21.

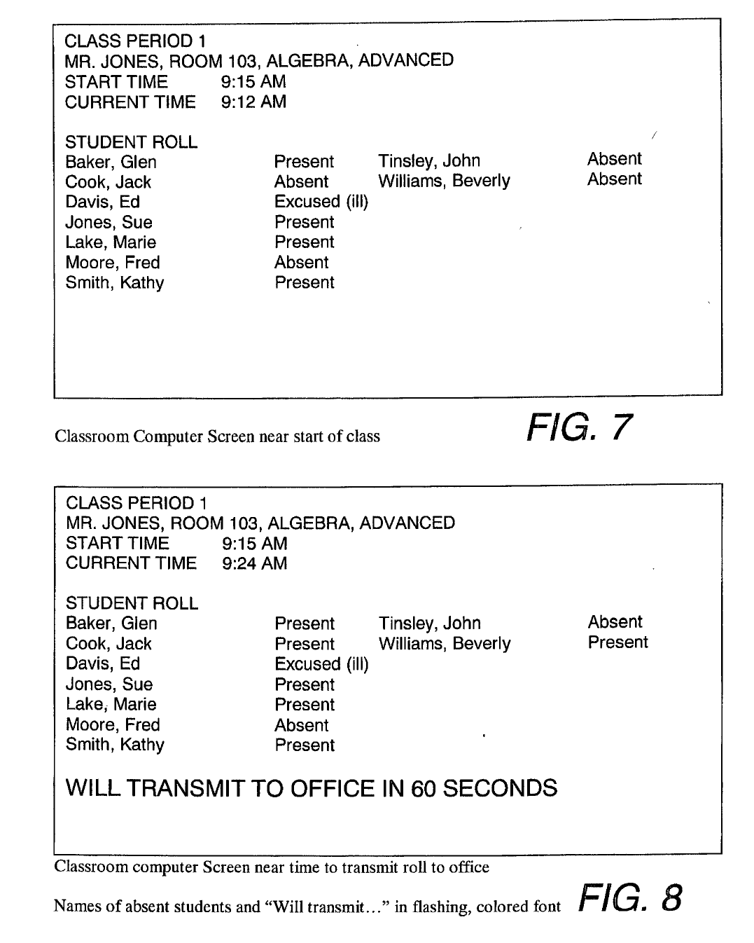

In FIGS. 7 and 8 the information concerning absentees and the time and location are all indicated on the computer monitor including, in FIG. 8, the time that the information will automatically be transmitted (“WILL TRANSMIT TO OFFICE IN 60 SECONDS”) to enable the authorized user, in this case the teacher, of the onsite computer 23 to alter any information as known by the authorized user regarding excused absences or other alterations prior to the transmission of the absentee information.

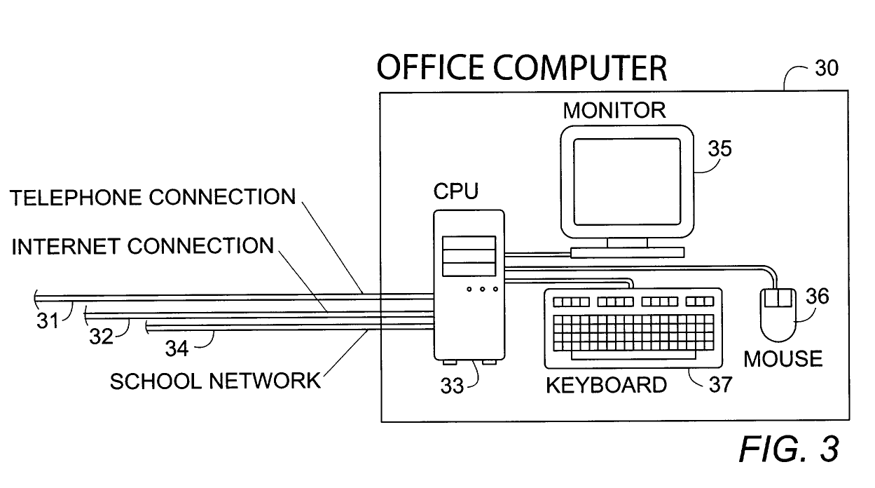

In FIGS. 1 and 3, the central computer means, in this case the office personal computer 30, is located in a school office 50 and communicates with the programmed onsite computer means, the onsite personal computers 23 via a cable 24 from each onsite personal computer 23 through a network switch 38 and through a cable 34. Each onsite computer means, the onsite personal computer 23, is programmed to send automatically absentee information to the central computer means, the office personal computer 30, regarding absences, and the central computer is programmed to compare the absentee information with information about excused absences and further programmed to send at least one report for each absentee to a preprogrammed report recipient within a set indicated time period, allowing time for human intervention.

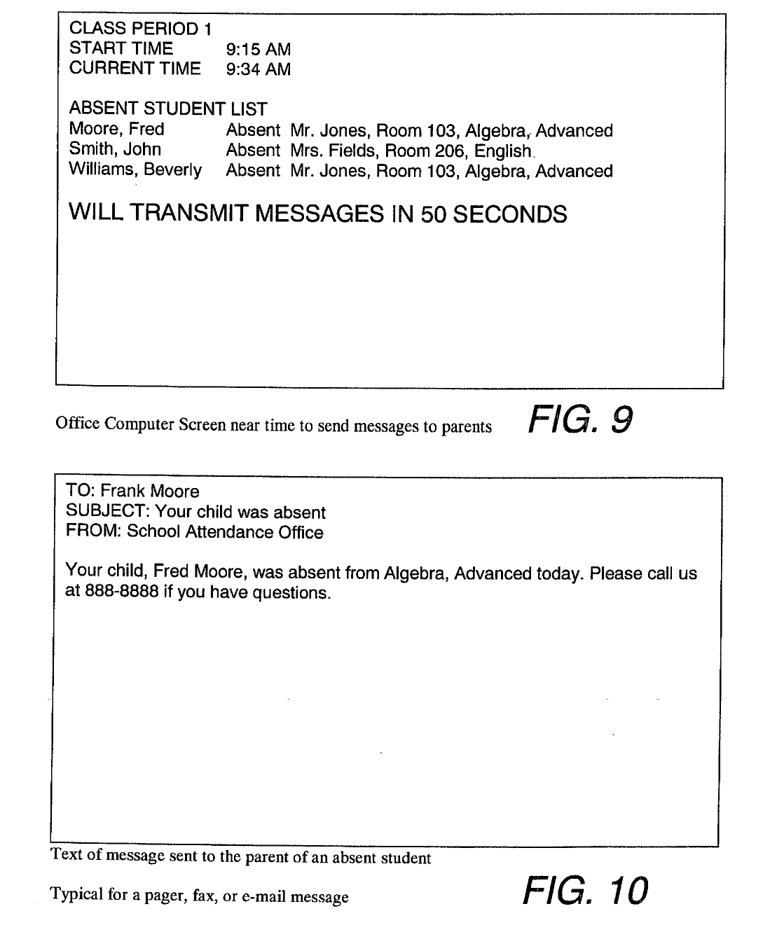

In FIG. 9, the office computer monitor shows the warning that the absentee information “WILL TRANSMIT MESSAGES IN 50 SECONDS”. FIG. 10 displays on the office personal computer monitor an actual message regarding an absentee which would be sent to the parent or guardian of the absentee student in this case.

In FIG. 3, the central computing means, in this case the office personal computer 30 with CPU 33, monitor 35, mouse 36, and keyboard 37 is programmed to report the absentee information automatically via one of a list of communication means including telephone or pager or FAX or e-mail or web site messages via a telephone line 31 or via an Internet connection 32. The absentee information can be reported automatically within minutes to a person responsible for the student.

The biometric information inputting means, in this case the fingerprint scanner 21 is further capable of receiving and analyzing biometric information of an authorized operator, in this case the teacher, of the onsite computer means so that the absence of the authorized operator is automatically reported to the central computer means 30 within a set time frame so that the authorized operator may be replaced.

The biometric information inputting means, in this case the fingerprint scanners 21, and the onsite computer means, the onsite personal computers 23 may be programmed to receive and transmit to the central computer means information about the departure of each individual from the location (students leaving the classroom 40 for example).

In FIG. 1, a portable biometric information inputting means, such as a portable fingerprint scanner 21A, and a portable computing means, such as a handheld PDA 60 with an antenna 61, may be used for monitoring any desired location to determine authorization of individuals in the desired location, such as hall monitors in schools monitoring students in the halls. Safety and health issues are programmable into the system, such as specific health conditions of individuals, so that appropriate assistance can be obtained as rapidly as possible.

While the embodiment illustrated in the present invention applies the system to a school environment, the at least one biometric information inputting means and the at least one onsite computer means may be located in a work or other location and the central computer means may be located in an office and worker absences or other absences are recorded and the absentee information is within minutes reported to a person responsible for the worker or other individual.

The at least one biometric information inputting means may comprise a fingerprint scanner positioned adjacent to a work location entrance and the onsite computer means may comprise a computer in the work location accessible to the worker supervisor.

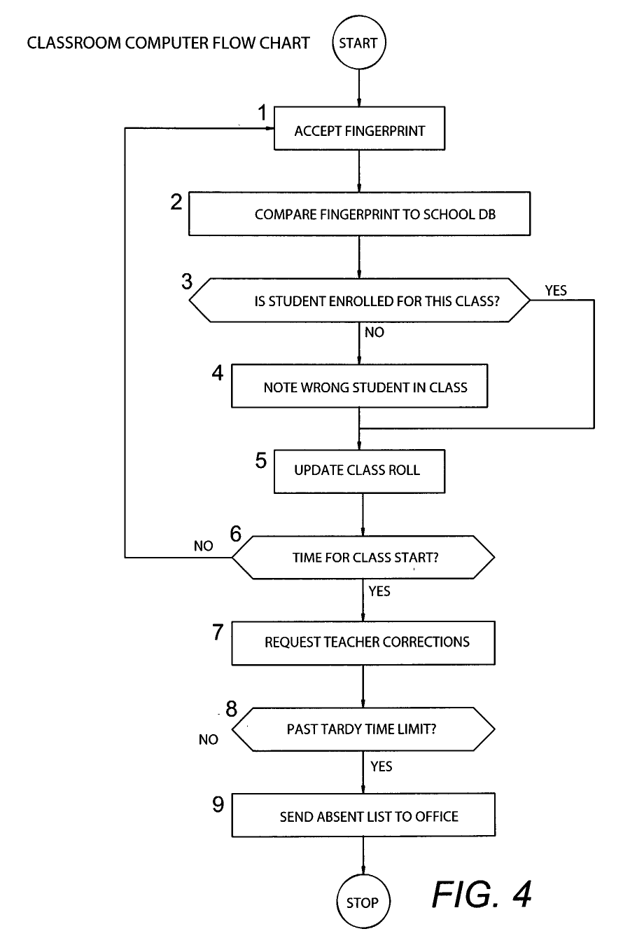

In practice, each classroom 40 has a fingerprint reader 21 (e.g. Idteck #FGR006) and communicates via RS-232 or RS-485 protocol to the classroom computer 23 (a typical Personal Computer with a windows operating system (e.g. Microsoft Windows2000)). The classroom computer 23 has an attendance application, programmed to perform according to the flow diagram of FIG. 4, that refers to a database of known fingerprints that is loaded via the school network (fiber-optic, 10/100 Base-T (Cat5 cable), or wireless (e.g. 802.11a or 802.11b)). As each student enters the classroom 40 the student touches the fingerprint reader 21. The reader shows a green or red LED indicating acceptance/rejection of the fingerprint (#1 on FIG. 4). As identification is made, the student ID is compared with the list of students enrolled for that class (#2 and 3, and possibly #4 for non-enrolled student with #5). At the start of the class (#6), the teacher can look at the computer screen to see who is missing and compare that list with who is there and who is excused. The teacher makes any necessary changes (#7). At some specified time after the start of class (e.g. 10 minutes) the classroom computer sends its list of absent students via the network to the office computer (#8 and 9). This time delay is related to whether a student is considered to be absent or just tardy. The system also allows the teacher to inform the office computer that a student (or the entire class) has been delayed at the end of a class and that information is relayed to the next class so that the student(s) will be expected to be tardy. The teacher can also relay information to the office and to the next teachers about behavioral issues regarding a specific student.

Fingerprint readers need time to search a database of known fingerprints for a match and it is important to reduce this dwell time for students entering a classroom. The first database checked would just have data on the students expected to be entering. If there is no match to the small database, the search would be expanded as required to include all known school fingerprints. If someone is entering who isn't expected, it is immediately flashed on the computer screen so that the teacher will immediately know it.

If a school wants to maximize control over students, it can use the fingerprint terminal for identifying students leaving the classroom, as well as entering. The most accurate way would be to have a fingerprint terminal for entering the classroom and another for exiting. Another way that is less expensive would be to have the classroom system assume that during the first half of the class session, that students are only entering and during the last half that students are only exiting. Another way would be to assume that if the student is marked as in the classroom, that the next time he is identified on the fingerprint terminal that he is exiting the classroom (after a time delay). It may also be worthwhile to have fingerprint terminals at common areas of the school, such as the library, cafeteria, or recreation area. This way, if the student is missing from the assigned classroom, his location may be known. In maximum situations, it would also be possible to require fingerprint identification to gain entry or to leave the school.

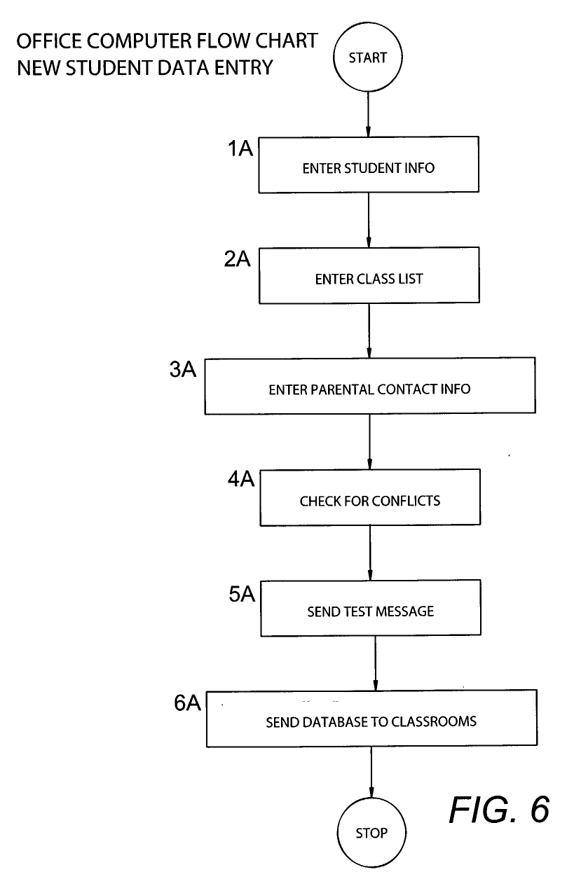

The office central computer 30 is a typical Personal Computer with a windows operating system (e.g. Microsoft Windows2000). It has a fax/modem (e.g. Zoom Telephonics #3025-00-00N) connected to a phone line 31 and an Internet connection 32. As shown in the flow diagram of FIG. 6, it has a database application that is used to load information on all students in the school (#1A) and the class lists (2A). This information includes the contact information (#3A) i.e. contact technique (fax, phone, pager, or e-mail), time delay (allowing for administrator intervention if required) text header information, and contact number. The program then checks for conflicts (#4A), sends test messages (#5A) and sends the database to the classroom computers 23 (#6A).

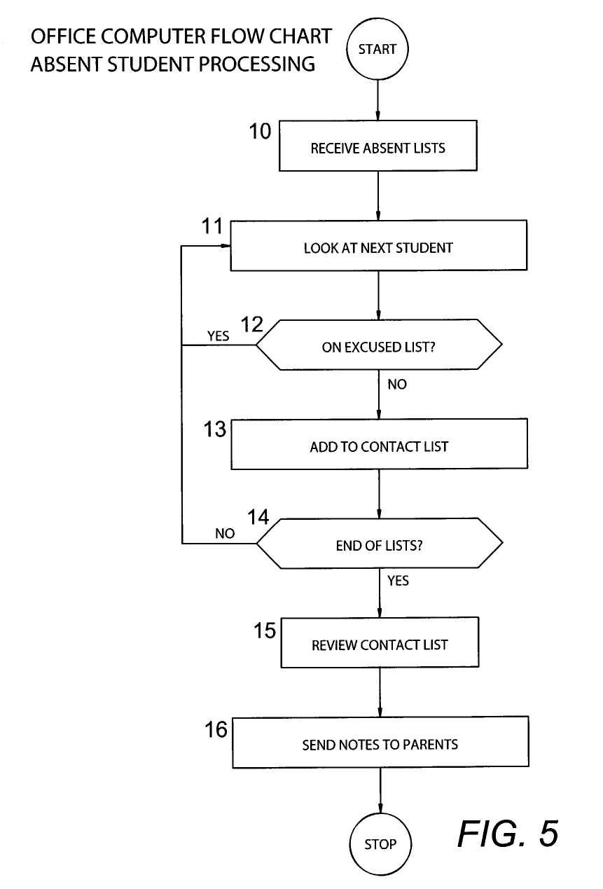

There is also a communications application loaded on the computer, programmed to function according to the flow diagram of FIG. 5. This application receives information from the classroom computer via the network as to who is absent (#10). The application checks each absent student (#11) for relevant information, checks for excused absences (#12), adds to the contact list (#13), checks to see that the list is complete (#14), and reviews and shows who is about to be contacted (#15) and after a time delay (as indicated in the onscreen message of FIG. 9) transmits the messages (#16). Messages that failed to connect (e.g. busy or no answer) are resent as required. Each communication time and the result of each communication are logged.

The student attendance data is stored for long-term reference by the school. If a parent does not want to participate, the contact information is left blank. If a parent doesn't want the school to collect fingerprint data on a student, a proximity reader RF card can be issued to the student. The fingerprint reader in each classroom can read the RF card as well as the fingerprint. If the time required to read a fingerprint causes congestion at the classroom door, additional fingerprint readers can be installed in the classroom.

A parent can request reports to be sent daily, weekly, or monthly on his child's attendance record. The report would be sent as fax or e-mail and could be different from his other contact technique. A parent could also be given a password to review the data on his child's attendance history or current whereabouts. This would be done through a web page. If the parent doesn't have web access, he could phone a school office clerk to gain the same information.

In addition to determining what students are absent, this technology can also determine if a teacher is missing from the classroom. The teacher could either log onto the classroom computer or use the fingerprint ID to be listed as present. Rather than having a time lag (e.g. 10 minutes for students) the system could instantly contact an administrator or department head so that a supervisor could instantly cover the classroom. The teacher's fingerprint could be used to log onto the classroom computer to give greater security. In the office, the fingerprint of office clerks and administrator can be used for computer security.

The student identification technique (fingerprint, RF Card, etc.) can also be used in the school cafeteria and bookstore in a POS (point of sale) computer system. Purchases of food or other items could be deducted from the student's account balance. Parent bank transfer or credit card could add money to this account. Using this technique would reduce the risk of the student loosing the money or spending the money for unintended purposes.

The office computer will send data to the web page database as required to keep it current. This will be done over the local area network or the Internet depending on where the web page is hosted.

The same theory of operation can be used for employee attendance at a business. Fingerprint or other identification can be used to show where employees are at what times. This data can be used for payroll calculations for hourly employees, client billings for project hours, or just keeping track of who is where. In some industries there is a requirement for a certain level of staffing for public safety or process control. If a staffing problem is noted, automatic notification can go to supervisors or others.

It is understood that the preceding description is given merely by way of illustration and not in limitation of the invention and that various modifications may be made thereto without departing from the spirit of the invention as claimed.

What is claimed is:

1. An automated identification and reporting system for inputting and analyzing biometric information to detect and report absences automatically and instantaneously, the system comprising:
at least one biometric information inputting means for receiving biometric information from individuals at a location where the individuals are scheduled for attendance;
at least one programmed onsite computer means at the location communicating with the biometric information inputting means, the computer means programmed with a timed sequence of recording the information and comparing the stored biometric information of the individuals who are scheduled for attendance with the biometric information input by the individuals actually in attendance to detect absences and allow a set indicated period of time for human input to make corrections;
a central computer means communicating with the at least one programmed onsite computer means, wherein the onsite computer means is capable of sending absentee information to the central computer regarding absences, and the central computer is capable of comparing the absentee information with information about excused absences and further capable of sending at least one report for each absentee to a preprogrammed report recipient within a set indicated time period, allowing for human intervention.

2. The system of claim 1 wherein the at least one biometric information inputting means is further capable of receiving and analyzing biometric information of an authorized operator of the onsite computer means so that the absence of the authorized operator is automatically reported to the central computer means within a set time frame so that the authorized operator may be replaced.

3. The system of claim 1 wherein the central computing means is capable of reporting the absentee information automatically via one of a list of communication means including telephone, pager, e-mail, FAX, and web site messages.

4. The system of claim 1 wherein the at least one biometric information inputting means and the onsite computer means are further capable of receiving and transmitting to the central computer means information about the departure of each individual from the location.

5. The system of claim 1 further comprising a portable biometric information inputting means and a portable computing means for monitoring any desired location to determine authorization of individuals in the desired location.

6. The system of claim 1 wherein the at least one biometric information inputting means and the at least one onsite computer means are located in a classroom and the central computer means is located in a school office and student absences are recorded and the absentee information is within minutes reported to a person responsible for the student.

7. The system of claim 6 wherein the at least one biometric information inputting means comprises a fingerprint scanner positioned adjacent to a classroom entrance and the onsite computer means is a computer in the classroom accessible to the classroom instructor.

8. The system of claim 1 wherein the at least one biometric information inputting means and the at least one onsite computer means are located in a work location and the central computer means is located in an office and worker absences are recorded and the absentee information is within minutes reported to a person responsible for the worker.

9. The system of claim 6 wherein the at least one biometric information inputting means comprises a fingerprint scanner positioned adjacent to a work location entrance and the onsite computer means is a computer in the work location accessible to the worker supervisor.
